(19) United States
(12) Patent Application Publication
(10) Pub. No.: US 2006/0280105 A1
(43) Pub. Date: Dec. 14, 2006

(54) Optical disk recording and reproducing apparatus

(75) Inventors: Takahiro Toyoda, Tokyo (JP); Koji Ashizaki, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/446,295

(22) Filed: Jun. 5, 2006

(30) Foreign Application Priority Data
Jun. 10, 2005 (JP) P2005-170789

(51) Int. Cl. G11B 3/70

(52) U.S. Cl. 369/272.1

(57) ABSTRACT

An optical disc recording and reproducing apparatus for executing recording and reproduction of an optical disc on which a loop-shaped antenna coil having an IC chip has been arranged and communicating with the IC chip by an electromagnetic wave is disclosed. An antenna coil of a reader or writer apparatus for communicating with the IC chip is arranged on the side of an optical pickup module which faces a rotary axis of the optical disc.

### CROSS REFERENCES TO RELATED APPLICATIONS

The present invention contains subject matter related to Japanese Patent Application JP 2005-170789 filed in the Japanese Patent Office on Jun. 10, 2005, the entire contents of which being incorporated herein by reference.

### BACKGROUND OF THE INVENTION

1. Field of the Invention

The invention relates to an optical disc recording and reproducing apparatus and, more particularly, to an optical disc recording and reproducing apparatus for executing recording and reproduction of an optical disc in which a loop-shaped antenna coil having an IC (Integrated Circuit) chip has been arranged and communicating with the IC chip by an electromagnetic wave.

2. Description of the Related Arts

In recent years, there have been proposed optical discs such as CD-ROM (Compact Disc Read Only Memory), DVD (Digital Versatile Disc), and the like on each of which an IC chip for storing management information and the like of the optical disc has been arranged (for example, refer to the following Patent Documents 1, 2, 3, and 4).

[Patent Document 1] JP-A-1997(Heisei 9)-245381
(Paragraph No. [0013], FIG. 1)

[Patent Document 2] JP-A-2001-291079
(Paragraph No. [0155], FIG. 47)

[Patent Document 3] JP-A-2000-215456
(Paragraph No. [0028], FIG. 3)

[Patent Document 4] JP-A-2000-132871
(Paragraph No. [0044], FIGS. 10 and 13)

According to the IC chip arranged on the optical disc, since reading and writing of information can be performed in a contactless manner by communicating with a reader/writer in or out of the optical disc recording and reproducing apparatus such as a DVD drive or the like by using an electromagnetic wave, such an IC chip can be used for management or the like of the optical disc.

FIG. 7 is a diagram showing an optical disc having an IC chip.

An antenna coil 802 led out of an IC chip 801 is provided for an optical disc 800. For example, also as disclosed in Patent Documents 1 and 2, the antenna coil 802 has a loop shape having the same center as that of a rotary axis of the optical disc 800. By forming the antenna coil into such a shape, when the IC chip 801 is communicated with an antenna coil of a reader/writer fixed in an optical disc recording and reproducing apparatus, the communication can be made without depending on the direction where the optical disc 800 is put on a disc tray of the optical disc recording and reproducing apparatus. Also in this case, by forming the antenna coil of the reader/writer in the optical disc recording and reproducing apparatus into a loop shape, the efficient communication can be made (refer to Patent Documents 3 and 4).

The optical disc recording and reproducing apparatus in the related art will be described hereinbelow.

FIG. 8 is a diagram showing a construction of a main part of the optical disc recording and reproducing apparatus in the related art.

FIG. 9 is a diagram showing a cross sectional view taken along the line B-B in the optical disc recording and reproducing apparatus in FIG. 8.

The optical disc recording and reproducing apparatus has: a spindle portion 811 for rotating the optical disc put on a disc tray 810; an optical pickup module 812 for optically reading information recorded on the optical disc or writing information onto the optical disc by focusing control, tracking control, and the like; and a sled portion 813 for moving the optical pickup module 812 in the radial direction of the optical disc. As shown in FIG. 9, the spindle portion 811 includes: a chucking portion 811a for fixing the optical disc; and a spindle motor 811b for rotating the optical disc. The spindle portion 811 further has a reader/writer control unit 815 for allowing an antenna coil 814 to generate a predetermined magnetic field and allowing the information in the IC chip 801 arranged on the optical disc 800 as shown in FIG. 7 to be read out in a contactless manner. For example, the antenna coil 814 in the loop shape shown here is formed by concentrically or spirally turning the coil (coils) by the turn number of one or more. A center of the antenna coil 814 almost coincides with a center of the spindle portion 811.

FIG. 10 is a diagram showing a construction of a main part of the optical disc recording and reproducing apparatus when the optical disc has been loaded.

FIG. 11 is a diagram showing a cross sectional view taken along the line C-C in the optical disc recording and reproducing apparatus when the optical disc has been loaded in FIG. 10.

In the optical disc recording and reproducing apparatus in the related art, as shown in FIG. 10, the center of the optical disc 800, the center of the spindle portion 811, and the center of the antenna coil 814 of the reader/writer control unit 815 almost coincide.

As shown in FIG. 11, the optical disc 800 is constructed by adhering a recording layer 800b made of a metal film onto a disc substrate 800a and is put onto the disc tray 810 so that the recording layer 800b faces the optical pickup module 812. The IC chip 801 and the loop-shaped antenna coil 802 led out of the IC chip 801 are arranged on the disc substrate 800a. For example, the antenna coil 802 is formed by concentrically or spirally turning the coil (coils) by the turn number of one or more. By setting a radius of the antenna coil 802 and a radius of the antenna coil 814 of the reader/writer control unit 815 to an almost same value and arranging those antenna coils so as to face each other, the antenna coils 802 and 814 are electromagnetically induction coupled by an alternating magnetic field which is generated from the antenna coil 814 of the reader/writer control unit 815, so that the efficient communication with the IC chip 801 can be made.

### SUMMARY OF THE INVENTION

However, in the case of communicating with the IC chip arranged on the optical disc by the magnetic field in the optical disc recording and reproducing apparatus in a manner similar to that in the related art, there are the following problems.

FIGS. 12A and 12B are diagrams for explaining an influence that is exerted on the optical pickup module by the magnetic field which is generated in the antenna coil of the reader/writer. FIG. 12A is the diagram showing the case where a loop diameter of the antenna coil is large. FIG. 12B is the diagram showing the case where the loop diameter of the antenna coil is small.

The same component elements as those in FIG. 8 are designated by the same reference numerals. Each arrow shows a magnetic line of force. In both of FIGS. 12A and 12B, although there is a difference between degrees of the influence due to loop diameters of antenna coils 814a and 814b, a coil or the like which is used in the optical pickup module 812 is influenced by the generated magnetic field. There is consequently such a problem that if communication with the IC chip arranged on the optical disc is made during the rotating operation of the optical disc, some troubles occur in the focusing servo control, the tracking control, and the like and an erroneous operation occurs in the reading and writing of the optical disc.

FIGS. 13A and 13B are diagrams showing a difference between the necessary magnetic fields due to a material of the surface of the optical disc on which the IC chip is arranged. FIG. 13A is the diagram in the case where the IC chip is arranged on a non-conductive film. FIG. 13B is the diagram in the case where the IC chip is arranged on the surface where a conductive film exists.

The same component elements as those in FIG. 10 are designated by the same reference numerals. Each arrow shows a magnetic line of force and an intensity of the magnetic field is diagrammatically illustrated by a thickness of the arrow. As compared with the case where the IC chip 801 is arranged on a non-conductive film 800c as shown in FIG. 13A, in the case where the IC chip 801 is arranged on the surface where a conductive film 800d serving as a recording film exists as shown in FIG. 13B, the strong magnetic field is necessary for the stable communication. This is because in the case of the conductive film 800d, an energy which is supplied to the antenna coil (refer to FIG. 11) on the optical disc from the antenna coil 814 of the reader/writer is partially lost by an eddy current which is generated in the conductive film 800d. That is, in the case where the IC chip 801 is arranged on the surface where the conductive film 800d exists, in the optical disc recording and reproducing apparatus in the related art, a possibility of the occurrence of the erroneous operation mentioned above increases and it is further difficult to make the communication with the IC chip arranged on the optical disc during the reading and writing of the optical disc.

The invention is made in consideration of the foregoing problems and it is desirable to provide an optical disc recording and reproducing apparatus in which communication with an IC chip arranged on an optical disc can be made even during the rotating operation of the optical disc without causing an erroneous operation in the reading and writing.

According to an embodiment of the present invention, there is provided an optical disc recording and reproducing apparatus for executing recording and reproduction of an optical disc on which a loop-shaped antenna coil having an IC chip has been arranged and communicating with the IC chip by an electromagnetic wave, wherein an antenna coil of a reader or writer apparatus for communicating with the IC chip is arranged on the side of an optical pickup module which faces a rotary axis of the optical disc.

According to the above construction, since the antenna coil of the reader or writer apparatus for communicating with the IC chip of the optical disc is arranged on the side of the optical pickup module which faces the rotary axis of the optical disc, an influence that is exerted on the optical pickup module by a magnetic field which is generated in the antenna coil is reduced and even if the communication with the IC chip is made during the recording or reproduction of the optical disc, no erroneous operation occurs.

According to an embodiment of the present invention, since the antenna coil of the reader or writer apparatus for communicating with the IC chip of the optical disc is arranged on the side of the optical pickup module which faces the rotary axis of the optical disc, the influence that is exerted on the optical pickup module by the magnetic field which is generated in the antenna coil can be reduced and even if the communication with the IC chip is made during the recording or reproduction of the optical disc, the occurrence of the erroneous operation can be prevented.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a constructional diagram of a main part of an optical disc recording and reproducing apparatus according to an embodiment;

FIG. 2 is a constructional diagram of the main part of the optical disc recording and reproducing apparatus in the embodiment in the case where an optical disc has been loaded;

FIG. 3 is a diagram showing a cross sectional view taken along the line A-A in FIG. 2 and showing processing blocks of the optical disc recording and reproducing apparatus;

FIG. 4 is a diagram showing the case where an antenna coil on the reader/writer side has a rectangular shape;

FIG. 5 is a diagram showing a layout of the antenna coil on the reader/writer side used for experiments in the optical disc recording and reproducing apparatus;

FIGS. 6A and 6B are diagrams showing-examples of the antenna coil on the reader/writer side;

FIG. 7 is a diagram showing an optical disc having an IC chip;

FIG. 8 is a diagram showing a construction of a main part of an optical disc recording and reproducing apparatus in the related art;

FIG. 9 is a diagram showing a cross sectional view taken along the line B-B in the optical disc recording and reproducing apparatus in FIG. 8;

FIG. 10 is a diagram showing the construction of the main part of the optical disc recording and reproducing apparatus in the case where the optical disc has been loaded;

FIG. 11 is a diagram showing a cross sectional view taken along the line C-C in the optical disc recording and reproducing apparatus in the case where the optical disc has been loaded in FIG. 10;

FIGS. 12A and 12B are diagrams for explaining an influence that is exerted on an optical pickup module by a magnetic field which is generated in an antenna coil of a reader/writer;

FIG. 12A is the diagram showing the case where a loop diameter of the antenna coil is large;

FIG. 12B is the diagram showing the case where the loop diameter of the antenna coil is small;

FIGS. 13A and 13B are diagrams showing a difference between the necessary magnetic fields due to a material of the surface of the optical disc on which an IC chip is arranged;

FIG. 13A is the diagram in the case where the IC chip is arranged on a non-conductive film; and

FIG. 13B is the diagram in the case where the IC chip is arranged on the surface where a conductive film exists.

### DETAILED DESCRIPTION OF THE PREFERRED EMBODIMENTS

An embodiment of the present invention will be described in detail hereinbelow with reference to the drawings.

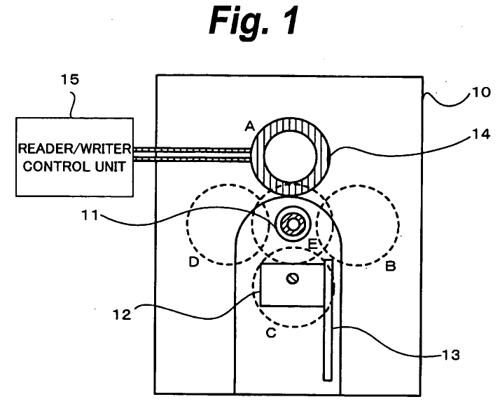

FIG. 1 is a constructional diagram of a main part of an optical disc recording and reproducing apparatus according to the embodiment.

The optical disc recording and reproducing apparatus according to the embodiment is, for example, a CD drive, a DVD drive, or a blu-ray disc drive for executing recording and reproduction of a blu-ray disc. The optical disc recording and reproducing apparatus has: a spindle portion 11 for rotating an optical disc-put on a disc tray 10; an optical pickup module 12 for optically reading information recorded on the optical disc or writing information onto the optical disc by focusing control, tracking control, and the like; and a sled portion 13 for moving the optical pickup module 12 in the radial direction of the optical disc. The optical disc recording and reproducing apparatus further has a reader/writer control unit 15 for allowing an antenna coil 14 to generate a predetermined magnetic field and communicating in a contactless manner with the IC chip 801 arranged on the optical disc. In the optical disc recording and reproducing apparatus of the embodiment, although the antenna coil 14 of the reader/writer control unit 15 shown in FIG. 1 has a loop shape in a manner similar to that in the related art, a center of the antenna coil 14 does not coincide with a rotary axis of the optical disc, that is, a center of the spindle portion 11 but the antenna coil 14 is arranged on the side of the optical pickup module 12 which faces the rotary axis of the optical disc. Although not shown, the antenna coil 14 is formed by concentrically or spirally turning the coil (coils) by the turn number of one or more.

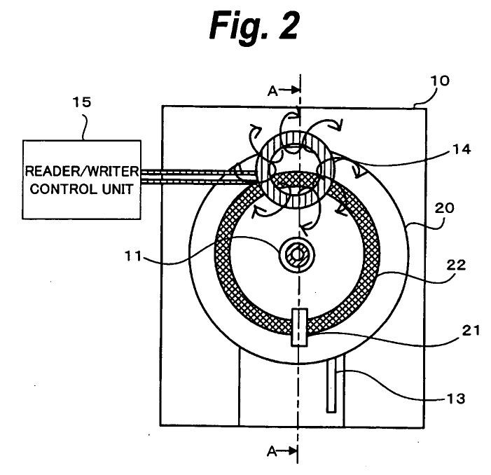

FIG. 2 is a constructional diagram of the main part of the optical disc recording and reproducing apparatus in the embodiment in the case where the optical disc has been loaded.

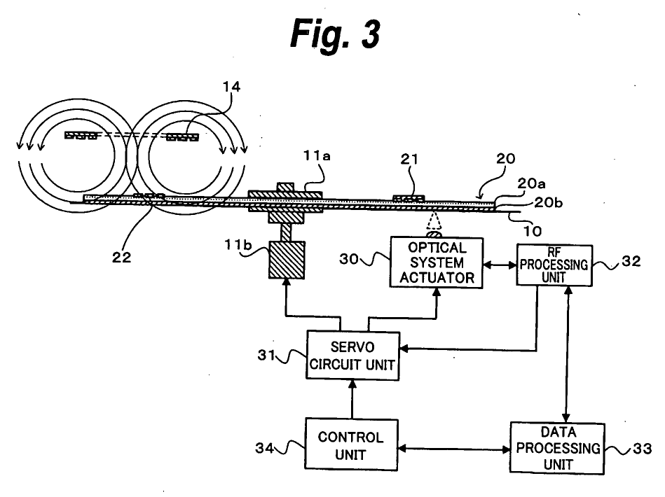

FIG. 3 is a diagram showing a cross sectional view taken along the line A-A in FIG. 2 and showing processing blocks of the optical disc recording and reproducing apparatus.

An IC chip 21 is arranged on an optical disc 20 and a loop-shaped antenna coil 22 led out of the IC chip 21 is further arranged on the optical disc 20. In the example of FIG. 3, the optical disc 20 has such a structure that a recording layer 20b made of a metal film has been formed on an optical disc substrate 20a by a sputtering process. The optical disc 20 is arranged on the disc tray 10 so that the recording layer 20b faces the optical pickup module 12 (included in an optical system actuator 30 in FIG. 3). The IC chip 21 and the loop-shaped antenna coil 22 led out of the IC chip 21 are arranged on the disc substrate 20a or its inside. Although not shown, for example, the antenna coil 22 is formed by concentrically or spirally turning the coil (coils) by the turn number of one or more. Various kinds of information such as peculiar information of the optical disc, information of the recorded contents, information of copy protection or the like, information of a result of a game, and the like can be stored in the IC chip 21.

As shown in FIG. 3, the spindle portion 11 includes: a chucking portion 11a for fixing the optical disc 20; and a spindle motor 11b for rotating the optical disc 20. For example, the chucking portion 11a fixes the optical disc 20 by a magnet.

When the information recorded on the optical disc 20 is reproduced or the information is recorded onto the optical disc 20, the processing blocks shown in FIG. 3 are used. Such a structure is similar to that of the optical disc recording and reproducing apparatus in the related art.

The optical system actuator 30 includes the foregoing optical pickup module 12 and has: a coil for a focusing drive; a coil for driving a tilt mechanism for a skew servo; a coil for a tracking drive; a coil for a sledding drive; and the like.

A servo circuit unit 31 controls the operations of the spindle motor 11b and the optical system actuator 30.

An RF processing unit 32 executes a waveform shaping process or the like to an RF signal which has been read out of the optical disc 20 and outputted from the optical pickup module 12 of the optical system actuator 30 or supplies a recording signal to be recorded onto the optical disc 20 to the optical pickup module 12 of the optical system actuator 30. The RF processing unit 32 returns detected focusing information, tracking information, and the like to the servo circuit unit 31.

A data processing unit 33 executes a signal process of the reproduction signal or the recording signal.

A control unit 34 is, for example, a CPU (Central Processing Unit). The control unit 34 transmits and receives data to/from the data processing unit 33 and sends a control signal to the servo circuit unit 31.

The operation of the optical disc recording and reproducing apparatus in the embodiment will be described hereinbelow with reference to FIGS. 1 to 3.

When the information is read out of the optical disc 20, the servo circuit unit 31 drives the spindle motor 11b and the optical system actuator 30 on the basis of the control signal from the control unit 34. Under the control of the servo circuit unit 31, the optical pickup module 12 of the optical system actuator 30 detects the information recorded in the recording layer 20b of the optical disc 20 as an RF signal and sends it to the RF processing unit 32. The RF processing unit 32 executes the waveform shaping process or the like to the RF signal. The RF processing unit 32 returns the detected focusing information and tracking information to the servo circuit unit 31. The servo circuit unit 31 adjusts the spindle motor 11b and the optical system actuator 30 on the basis of those information and continues to read out the information on the basis of the control signal from the control unit 34. The RF signal processed by the RF processing unit 32 is inputted to the data processing unit 33 and processed as a reproduction signal.

When the information is written onto the optical disc 20, the servo circuit unit 31 also similarly drives the spindle motor 11b and the optical system actuator 30 on the basis of the control signal from the control unit 34, thereby allowing the recording signal from the data processing unit 33 to be recorded into a predetermined position of the optical disc 20 through the RF processing unit 32.

When the reader/writer control unit 15 receives a signal indicative of the start of the communication with the IC chip 21 at predetermined timing, the unit 15 supplies a predetermined current to the antenna coil 14, thereby allowing an alternating magnetic field of a predetermined field intensity to be generated. Therefore, the antenna coil 22 of the optical disc 20 is electromagnetically induction coupled with the antenna coil 14 of the reader/writer control unit 15 on the side of the optical pickup module 12 (optical system actuator 30) which faces the rotary axis of the optical disc 20. Thus, the communication can be made between the IC chip 21 and the reader/writer control unit 15 and the information in the IC chip 21 can be read out or the information can be recorded into the IC chip 21.

Also in the case where the antenna coil 14 is arranged in any one of positions B to E shown by broken lines instead of a position A in FIG. 1, the communication with the IC chip 21 can be made by outputting a signal of the predetermined field intensity to the antenna coil 14 by the reader/writer control unit 15. However, when the antenna coil 14 is arranged in any one of the positions B to E, upon recording and reproduction of the optical disc 20, the optical system actuator 30 in FIG. 3 is influenced by the magnetic field generated in the antenna coil 14 and causes an erroneous operation. In the case of the position E, the reader/writer control unit 15 can communicate with the IC chip 21 by the output field intensity smaller than those in the cases of the positions A to D. However, when the loop diameter is small, there is a case where the communication is hindered by an influence of the chucking portion 11a using parts of a conductive material such as a metal or the like. Therefore, it is difficult to largely reduce the output field intensity. Consequently, there is also a case where an influence is exercised on the coil of the spindle portion 11 and the stationary rotation of the spindle portion 11 is hindered. When the loop diameter is relatively large, since a distance from the optical pickup module 12 is small, it is more liable to influence the module 12.

As compared with the positions B to E, by arranging the antenna coil 14 in the position A on the side of the optical pickup module 12 which faces the rotary axis of the optical disc 20 in a manner similar to the optical disc recording and reproducing apparatus in the embodiment, the communication with the IC chip 21 can be made without causing the erroneous operation in the optical system actuator 30 even during the recording or reproduction of the optical disc 20. Consequently, for example, it is possible to realize a powerful copy right protecting system in which while a disc peculiar ID recorded on the optical disc 20 is reproduced and read out, copyright protection information recorded in the IC chip 21 is read out and compared with the ID, thereby discriminating whether or not the disc is an authentic disc. It is also possible to realize various applications such as an application in which elapse information or the like of a game is automatically recorded into the IC chip 21 during the play of the game and the like.

Although the antenna coil 14 on the reader/writer side has the loop shape in the above explanation, if the antenna coil 14 is not arranged concentrically with the antenna coil 22 of the optical disc 20 in a manner similar to the optical disc recording and reproducing apparatus in the embodiment, the antenna coil on the reader/writer side does not necessarily have the loop shape.

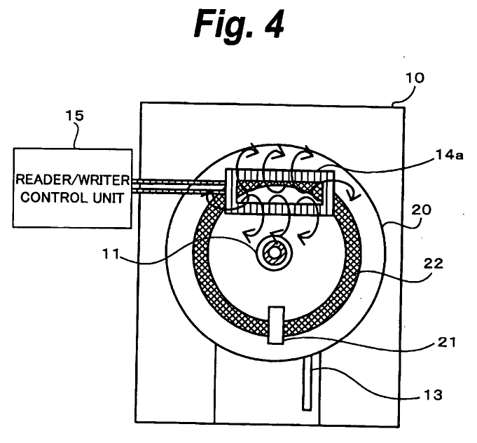

FIG. 4 is a diagram showing the case where the antenna coil on the reader/writer side has a rectangular shape.

In the case of using such a rectangular antenna coil 14a, by arranging the antenna coil 14a so that one side in the longitudinal direction of the rectangle is located along a part of the loop-shaped antenna coil 22 of the optical disc 20, communicating efficiency can be improved and even if the magnetic field is not so large, the stable communication can be maintained.

Such a rectangular antenna coil 14a is arranged in several positions above the optical disc 20 and experiments to discriminate whether or not an influence is exerted on the recording and reproduction of the optical disc 20 were performed.

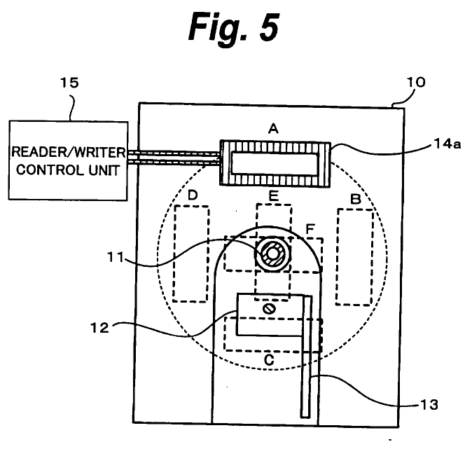

FIG. 5 is a diagram showing a layout of the antenna coil on the reader/writer side used for the experiments in the optical disc recording and reproducing apparatus.

In the diagram, the optical disc 20 is not shown and the position where the optical disc 20 is arranged is shown by a circular broken line.

The used antenna coil 14a on the reader/writer side has a rectangular shape of (25 mm ×60 mm) and the antenna turn number is set to 2. An outer diameter of the loop-shaped antenna coil on the optical disc 20 side is set to 95 mm and the turn number is equal to 5. The experiments are performed by using a drive for a DVD.

When the rectangular antenna coil 14a is arranged at the positions A to F as shown in FIG. 5, communication can be made between the reader/writer control unit 15 whose output field intensity at the position which is away by a distance of 10 m is equal to or less than 4500 μV/m and the IC chip 21. However, the recording and reproduction of the optical disc 20 could normally be performed in the state where the output field intensity which enables the communication with the IC chip 21 has been applied only in the cases where the antenna has been arranged in the positions A and F. That is, it has been found that in the cases of the positions other than them, an influence was exerted on the optical system actuator 30. In the experiments, it is considered that the reason why the recording and reproduction could normally be performed also in the case where the antenna coil 14a has been arranged in the position F besides the position A is that the distance from the optical pickup module 12 is larger than those in the cases where the antenna coil 14a has been arranged in the positions B to E. However, in the case where the antenna coil 14a has been arranged in such a position, a large influence is exerted on the communication with the IC chip 21 in dependence on a material of parts constructing the chucking portion 11a (refer to FIG. 3). For example, when the parts made of a metal having high conductivity are used for the chucking portion 11a, the communication with the IC chip 21 is hindered. Therefore, it is difficult to obtain a good communication result in the state where an output of the reader/writer control unit 15 is fairly decreased. When the antenna size is enlarged at the position F, a result similar to that in the case where the erroneous operation is caused in the recording and reproduction at the position E is caused. Thus, the operation is restricted at the position F more than that at the position A. Therefore, it is most desirable to arrange the antenna coil 14a in the position A on the side of the optical pickup module 12 which faces the rotary axis of the optical disc 20.

Each of the coils having the following shapes may be used as an antenna coil 14 on the reader/writer side.

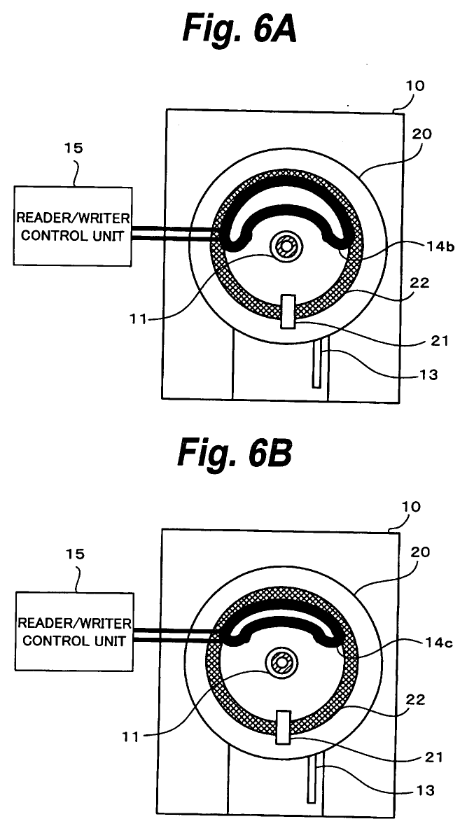

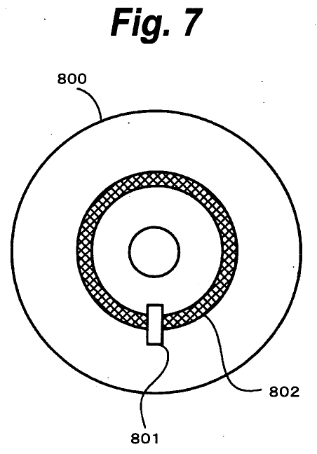

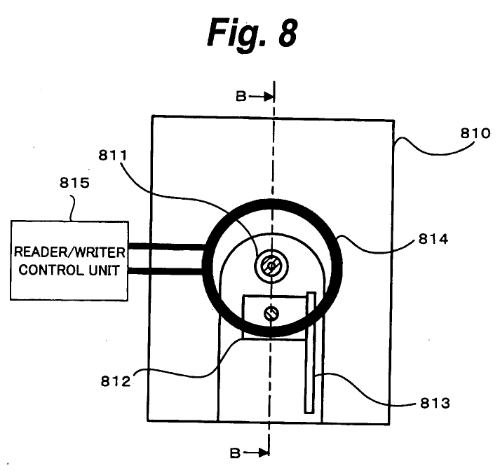

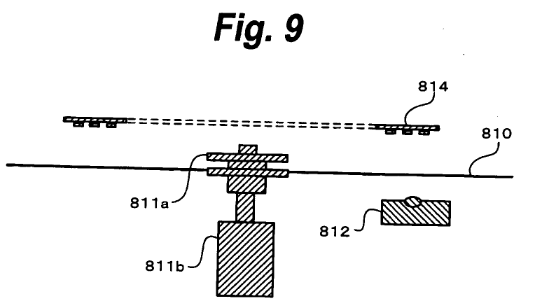

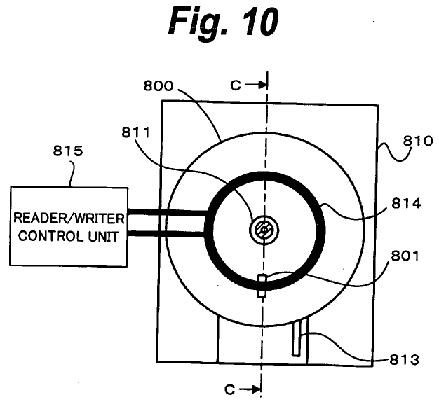

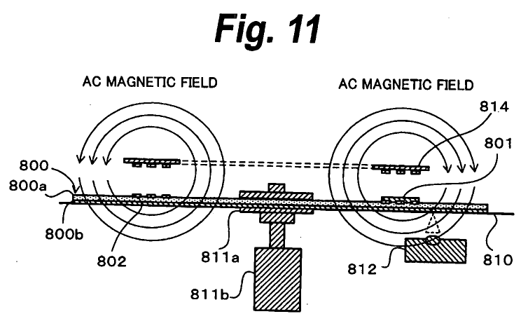

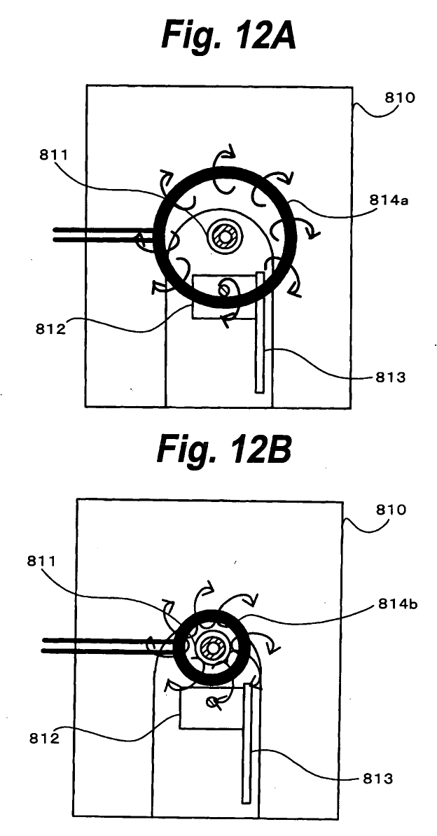

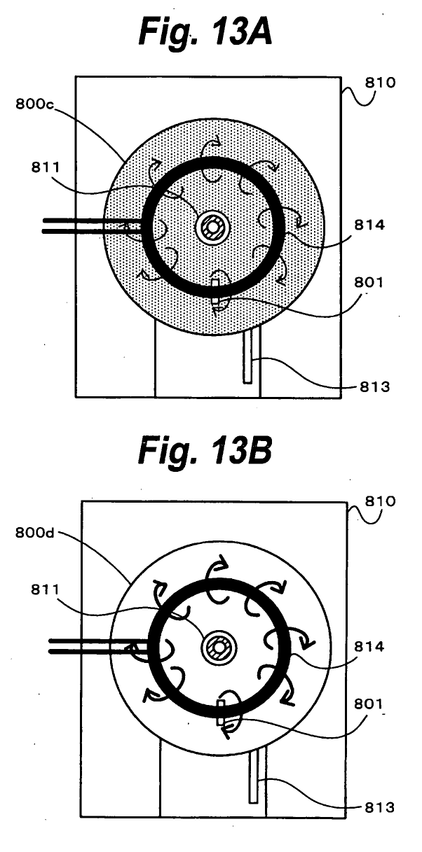

FIGS. 6A and 6B are diagrams showing examples of the antenna coil on the reader/writer side.

In each of antenna coils 14b and 14c on the reader/writer side in FIGS. 6A and 6B, a part of the coil forms an arc shape whose radius is almost equal to that of the loop-shaped antenna coil 22 led out of the optical disc 20 and the coil is arranged so that the arc-shaped portion is located along the antenna coil 22. In the antenna coil 14b in FIG. 6A, the arc-shaped portion is located along the arc of a semicircle of the antenna coil 22, thereby raising a coupling ratio of the electromagnetic induction coupling with the antenna coil 22. Other portions have a shape which is bent inwardly in order to assure the distance from the optical pickup module 12 (not shown in FIGS. 6A and 6B; refer to FIG. 1). In the antenna coil 14c in FIG. 6B, although an area along the arc of the antenna coil 22 of the optical disc 20 is smaller than that of the antenna coil 14b in FIG. 6A, the antenna coil 14c has a shape in which the larger distance from the optical pickup module 12 can be assured. The influence which is exerted on the optical system actuator 30 by the magnetic field upon communication with the IC chip 21 can be reduced.

Although the invention has been described above with respect to the case where the IC chip 21 and the antenna coil 22 have been arranged on the surface of the disc substrate 20a side, the invention is not limited to such a case. They may be embedded in the disc substrate 20a. Also in this case, in the optical disc recording and reproducing apparatus in the embodiment, since the antenna coil 14 on the reader/writer side has been arranged on the side opposite to the optical pickup module 12, even if the field intensity is raised, the influence on the optical system actuator 30 can be reduced.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc recording and reproducing apparatus for executing recording and reproduction of an optical disc on which a loop-shaped antenna coil having an IC chip has been arranged and communicating with said IC chip by an electromagnetic wave,
wherein an antenna coil of a reader or writer apparatus for communicating with said IC chip is arranged on the side of an optical pickup module which faces a rotary axis of said optical disc.

2. An apparatus according to claim 1, wherein said antenna coil is rectangular and is arranged so that one side in its longitudinal direction is located along a part of said loop-shaped antenna coil.

3. An apparatus according to claim 1, wherein a part of said antenna coil forms an arc shape whose radius is almost equal to that of said loop-shaped antenna coil and said antenna coil is arranged so that said arc-shaped portion is located along a part of said loop-shaped antenna coil.
